(19) United States
(12) Patent Application Publication
(10) Pub. No.: US 2005/0283428 A1
(43) Pub. Date: Dec. 22, 2005

(54) Systems and methods for electronic trading of carbon dioxide equivalent emission

(76) Inventors: Carlton Bartels, Staten Island, NY (US); Jane Bartels, Staten Island, NY (US); Adam White, New York, NY (US); Shelby White, Atlanta, GA (US); Melissa Turnage, Cockeysville, MA (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/204,825

(22) Filed: Aug. 16, 2005

Related U.S. Application Data
(62) Division of application No. 09/967,375, filed on Sep. 28, 2001.
(60) Provisional application No. 60/296,019, filed on Jun. 5, 2001.

(51) Int. Cl. G06F 17/60

(52) U.S. Cl. 705/37

(57) ABSTRACT

Systems and methods for trading carbon dioxide equivalent (CO₂e) emissions reductions are provided. Users may construct bids, trade CO₂e emissions reductions, and formulate CO₂e emissions reduction plans. The electronic trading system may provide the user with the ability to develop and implement a customised CO₂e emission reductions strategy. The electronic-trading system may provide the user with the ability to electronically build a portfolio of CO₂e emission reductions. Transactions and emissions reductions may be documented so that users may demonstrate CO₂e emissions reductions to current and future regulatory agencies.

This application claims the benefit of U.S. provisional patent application No. 60/296,019, filed Jun. 5, 2001, which is hereby incorporated by reference herein in its entirety.

### BACKGROUND OF THE INVENTION

The present invention relates to systems and methods for trading. More particularly, the present invention relates to systems and methods for electronic trading of carbon dioxide equivalent emissions reductions.

Carbon dioxide equivalent (CO₂e) is the universal unit of measurement used to indicate the global warming potential of greenhouse gases. Some examples of greenhouse gases are carbon dioxide (CO₂), water vapor (H₂O), methane (CH₄), chlorofluorocarbons (CFCs), nitrous oxide (N₂O), hydrofluorocarbons (HFCs), perfluorocarbons (PFCs), and sulfur hexafluoride (SF₆). Possible methods of reducing CO₂e emissions include reducing actual emissions, avoiding potential emissions, or removing and storing atmospheric carbon in a sink. Emission reductions may qualify for accreditation under future international regulatory regimes, domestic regulatory regimes, or both.

In an evolving CO₂e emission reductions trading market, entities such as countries, corporations, non-profit organizations, or any other suitable entities may desire to gain a deeper understanding of the market. Such entities may, for example, need to develop and implement a CO₂e emission reductions strategy, construct bids and trade CO₂e emission reductions, and build a portfolio of CO₂e emission reductions.

Accordingly, it is desirable to provide systems and methods for electronic carbon dioxide equivalent emissions trading.

### SUMMARY OF THE INVENTION

In accordance with the present invention, systems and methods for electronic trading of carbon dioxide equivalent emissions reductions are provided. An electronic trading system may be provided for implementation of electronic trading. An electronic trading application may be used to provide the users with the ability to access the electronic trading system.

The electronic trading system may facilitate transactions of emission reductions between buyers and sellers. Trade requests may be saved and submitted to a broker at a later time. Also, trade requests may be edited and revised prior to submitting the trade to a broker, and requests may be amended after being submitted to a broker. Brokers may assist the user, either electronically through the electronic trading application or by phone, in the development of a marketable bid. Once a bid has been generated, transactions may be broker intermediated. Trades may be documented to show reductions in emissions for a company and may assist in providing a basis for accreditation under future international and/or domestic carbon emission regulations.

Trades may be composed of a combination of immediate settlement, forwards, and options. Immediate settlement trades may be made where the terms of a bid and offer are set on the trade date with delivery and payment occurring in a standard timeframe shortly thereafter. Forward settlement trades may be made where the terms of a bid and offer are set on the trade date, but the delivery of reductions and payment are deferred to a future date also specified at the time of the trade. Options may be derivative products in which the parties may buy and sell the option, or right decided, whether or not to enter into a specific cash transaction at or before a future date (referred to as the strike date). Call option may allow a buyer to lock in the right to purchase reductions at a specified date at a specified price. Put options may allow a seller to lock in the right to sell reductions at a set price.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a schematic diagram of an illustrative electronic trading system suitable for implementation of an electronic trading system in accordance with some embodiments of the present invention;

FIG. 2 is a schematic diagram of illustrative computer equipment in accordance with some embodiments of the present invention;

FIG. 3 shows a flow diagram of a trade cycle in accordance with some embodiments of the present invention;

FIG. 4 shows a flow diagram for portfolio building in accordance with some embodiments of the present invention;

FIG. 5 shows an illustrative main menu screen of the carbon commerce web page that may be provided by an electronic trading application in accordance with some embodiments of the present invention;

FIG. 6 shows an illustrative log on screen that may be provided by an electronic trading application in accordance with some embodiments of the present invention;

FIG. 7 shows an illustrative trading menu screen that may be provided by the electronic trading application in accordance with some embodiments of the present invention;

FIG. 8 shows an illustrative forward market screen that may be provided by the electronic trading application in accordance with some embodiments of the present invention;

FIG. 9 shows an illustrative imperial/metric converter screen that may be provided by the electronic trading application in accordance with some embodiments of the present invention;

FIG. 10 shows an illustrative customisation screen that may be provided by the electronic trading application in accordance with some embodiments of the present invention;

FIG. 11 shows an illustrative market graph of selected data that may be provided by the electronic trading application in accordance with some embodiments of the present invention;

FIG. 12 shows an illustration options market screen that may be provided by the electronic trading application in accordance with some embodiments of the present invention;

FIG. 13 shows an illustrative trade request screen that may be provided by the electronic trading application in accordance with some embodiments of the present invention;

FIG. 14 shows an illustrative my trades screen that may be provided by the electronic trading application in accordance with some embodiments of the present invention;

FIG. 15 shows an illustrative tools menu screen that may be provided by the electronic trading application in accordance with some embodiments of the present invention; and

FIG. 16 shows an illustrative news and insights menu screen that may be provided by the electronic trading application in accordance with some embodiments of the present invention.

### DETAILED DESCRIPTION OF THE INVENTION

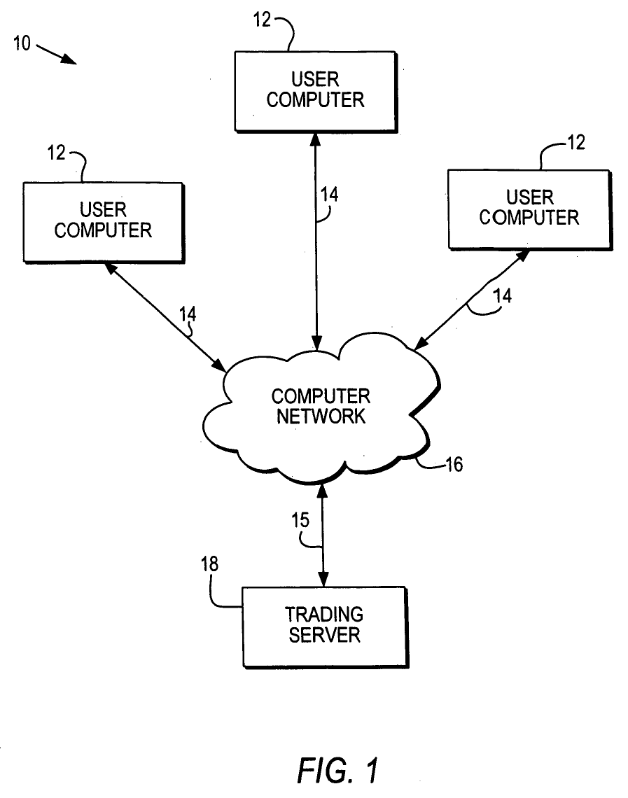

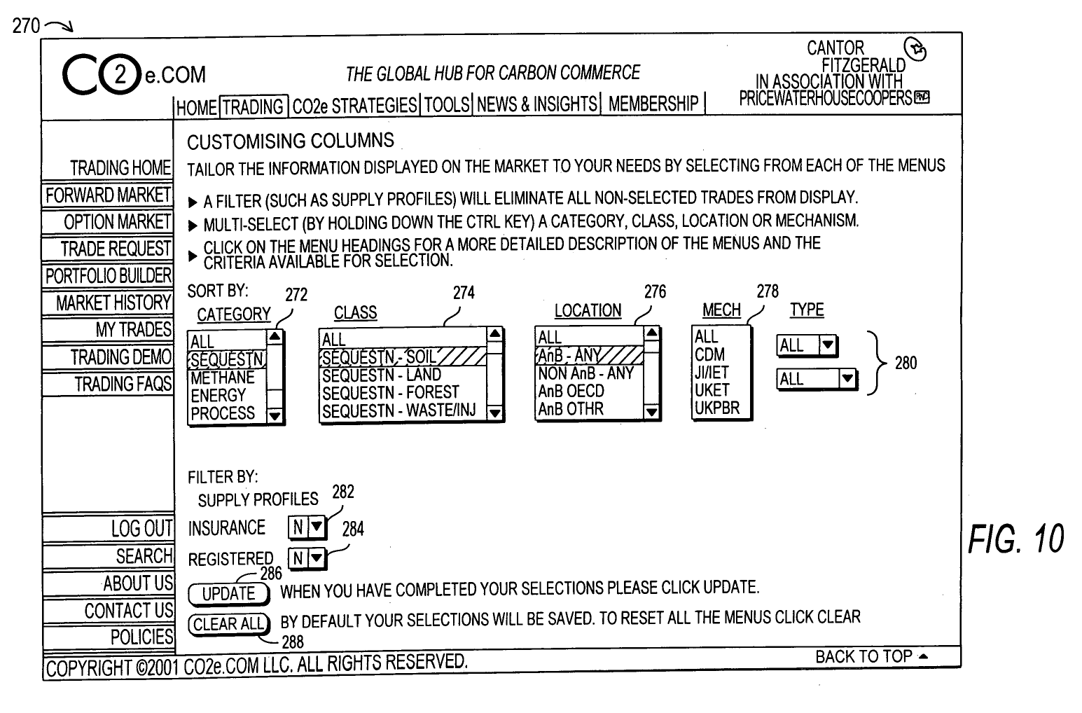

The present invention is now described in more detail in conjunction with FIGS. 1-16.

FIG. 1 is a schematic diagram of an illustrative electronic trading system 10 suitable for implementation of electronic trading in accordance with some embodiments of the present invention. Aspects of the invention apply to various types of electronic trading, but are described herein primarily in the context of electronic trading of carbon dioxide equivalent (CO₂e) emission reductions for specificity and clarity.

System 10 may be used to provide electronic trading to users of various computer equipment. An electronic trading application may be used to provide users with the ability to electronically trade CO₂e emission reductions. In one suitable approach, the electronic trading application may run locally on computer equipment. Computer equipment, such as user computer 12 may be a computer, processor, personal computer, laptop computer, handheld computer, personal digital assistant, computer terminal, any other suitable computing device, or a combination of such devices. In another suitable approach, the electronic trading application may run using a client-server or distributed architecture where a portion of the electronic trading application may be implemented locally on the computer equipment in the form of, for example, a client process. Anther portion of the electronic trading application may be implemented at a remote location, such as on a server or any other suitable equipment as, for example, a server process. A server such as trading server 18 may be any suitable server, processor, computer, data processing device, or a combination of such devices. In one example, trading server 18 may be a server powered by eSpeed, Inc.

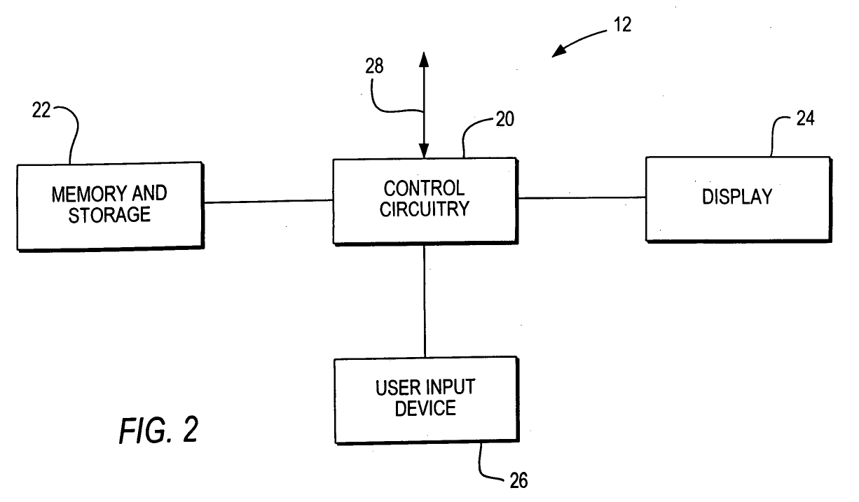

A generalized schematic diagram of user computer 12 is shown in FIG. 2. User computer 12 may include control circuitry 20, memory and storage 22, display 24, and user input device 26. Control circuitry 20 and memory and storage 22 may have communications, memory, and processing circuitry suitable for supporting functions such as accessing the electronic trading application over line 28. Line 28 may be coupled to communications links such as links 14 of FIG. 1. Text and graphics associated with the electronic trading application may be presented to a user using display 24. Display 24 may be a computer monitor, a handheld computer display, a laptop computer display, a personal digital assistant display, or any other suitable display equipment.

The user may interact with control circuitry 20 using any suitable user input device 26, such as a keyboard, a wireless keyboard, a mouse, a trackball, a touch pad, or any other suitable input device.

Referring back to FIG. 1, computer network 16 may a hub linking user computers 12 and trading server 18. Trading server 18 may be connected to computer network 16 by one or more communications links 15. Computer network 16 may be any suitable computer network including the Internet, an Intranet, a local-area network (LAN), a wide-area network (WAN), a metropolitan area network (MAN), a virtual private network (VPN), a wireless network, an optical network, an asynchronous transfer mode network (ATM), a cable network, a frame relay network, a digital subscriber line network (DSL), or a combination of such networks.

The components of system 10 may be interconnected using various communications links, such as links 14 and 15. Communications links 14 and 15 may include satellite paths, coaxial cable paths, fiber-optic paths, twisted pair paths, other wire or cable-based links, modems, wireless paths through free space, any other suitable paths, or a combination of such paths. Communications over communications links such as links 14 and 15 may involve analog transmissions, digital transmissions, wireless transmissions, microwave transmissions, radio-frequency transmissions, optical transmissions, audio transmissions, any other suitable type of transmissions, or a combination of such transmissions. Communications may involve Internet transmissions, private network transmissions, packet-based transmissions, television channel transmissions, transmissions in the vertical blanking interval (VBI) of a television channel or on a television sideband, MPEG transmissions, or any other suitable type of transmissions. Communications may involve wireless pager or other messaging transmissions. Communications links 14 and 15 may include cable connected to cable modems, digital subscriber lines, integrated services digital network (ISDN) lines, or any other suitable paths.

Traders or users at user computers 12 may participate in the electronic trading of CO₂e emission reductions by interacting with the electronic trading application. The electronic trading application may provide a user at user computer 12 with screens containing various trading and market information. For example, the user may be presented with screens that allow the user to make trades, view relevant trade information, or any other suitable screen in connection with the electronic trading of CO₂e emission reductions.

The electronic trading application may provide the user with interactive screens containing menus and selectable options that allow the user to navigate through the electronic trading application and participate in planning and electronic trading of CO₂e emission reductions. With user computer 12, the user may use a keyboard, mouse, trackball, touch pad, or other suitable input or pointing device to navigate the various menus and selectable options.

The user may access the electronic trading application by browsing to an Internet web site or a site on a private network, by running a local program, or by any other suitable method.

Systems and methods for electronic trading of carbon dioxide equivalent emission reductions are provided. Emission reductions may, for example, refer to a reduction in actual emissions, avoidance of potential emissions, or the removal and storage of atmospheric carbon in a sink. Users may, for example, invest in emission reductions in the anticipation that those reductions will qualify for accreditation under future international regulatory regimes, domestic regulatory regimes, or both. Emission reductions are referred to as carbon dioxide equivalent (CO₂e) emission reductions.

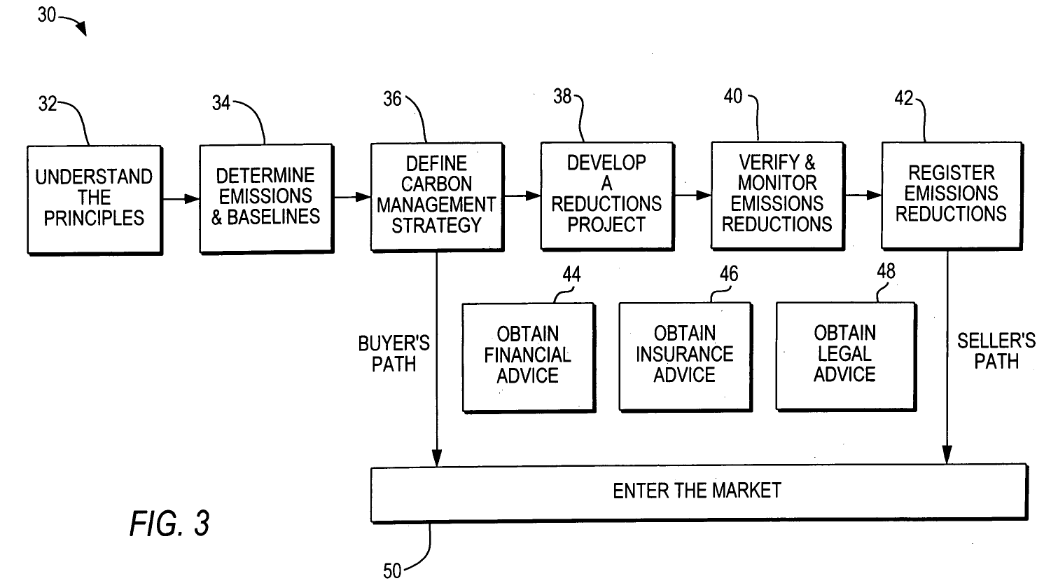

FIG. 3 shows a flow diagram of a trade cycle 30 that may be provided by the electronic trading system in accordance with some embodiments of the present invention. Trade cycle 30 may provide the user with the ability to develop and implement a customised CO₂e emission reductions strategy. In one suitable approach, the user may interact with various steps of trade cycle 30 using the electronic trading application. In another suitable approach, the user may interact with various steps of trade cycle 30 by interacting with personnel employed in connection with the electronic trading system. Hereinafter, personnel employed in connection with the electronic trading system will be referred to as CO₂e Associates. The user may interact with CO₂e Associates via the telephone or e-mail, through a chat screen associated with the electronic trading application, or by any other suitable method.

As shown in FIG. 3, trade cycle 30 may include an understand the principles step 32, a determine emissions and baselines step 34, a define carbon management strategy step 36, a develop a reductions project step 38, a verify and monitoring emissions reductions step 40, a register emissions reductions step 42, an obtain financial advice step 44, an obtain insurance advice step 46, an obtain legal advice step 48, and an enter the market step 50.

Understand the principles step 32 may be the first stage in trade cycle 30. Due to the potentially broad impact of any legislation limiting Greenhouse Gas (GHG) emissions, firms may incorporate climate change considerations in their corporate strategy to manage these business risks and maintain and enhance long-term competitive advantage. Knowledge of the development of global climate change policy and methods for mitigating emissions liabilities through internal action and CO2e trading may enhance the evaluation of the commercial opportunities and risks that may exist for firms exposed to climate change legislation. Using the electronic trading application, for example, the user may access policy and sector reports on a range of policy and industry issues related to climate change.

To assist users in defining the impact of climate change fundamentals, the electronic trading application may provide one or more screens that are accessible to the user which furnish an overview of major business-related climate change issues. The user may view a summary of the development of international climate change policy and plans for future policy developments. The user may also receive an overview of mechanisms in the Kyoto Protocol or other relevant environmental protocols. The user may also be able to select information on how mechanisms provide financial incentives for reducing emissions and facilitating the participation of developing countries. The user may also receive an overview of the key industry sectors affected by climate change and strategies on how to maximize opportunities for managing and enhancing the user's position in the marketplace. The user may also receive an overview of the types of reports available through the electronic trading application. The electronic trading application may include links to other suitable sources of information related to climate change issues.

Determine emissions and baselines step 34 may be the second stage in trade cycle 30 and may focus on the development of emission data for emitters. If the user or the user's company is a net emitter of Greenhouse Gas (GHG), the determination of the user's emission forecast may be an essential process in developing a cost-effective emission reduction strategy. This stage may assist the user in understanding the process for determining current emissions, forecasting emissions, and monitoring and reporting emissions.

Define carbon management strategy step 36 may be the next stage in trade cycle 30. Several different paths may exist to carbon compliance. Such paths may include internal emissions management, purchasing credits and allowances, and external project investment. The user may explore combinations of options to determine what may be an appropriate mix.

The electronic trading application may provide information related to GHG emission sources and abatement options which may be of importance to firms in managing their emission liability position. The electronic trading application may provide a variety of information sources to assist the user or corporation in developing and managing emissions information. Using the electronic trading application, the user may view information related to sources and main activities associated with producing GHG emissions and the concept of “system boundries” which may define the emissions for which a firm may be responsible. The user may also view information on baseline years and issues to consider when forecasting emissions and liabilities. In addition, a user may select “Monitoring and Reporting” in order to view information on issues related to the development of a monitoring and reporting methodology and system.

CO₂e Associates, for example, may assist the user by offering strategic advice on how the user may achieve an effective carbon management strategy in a manner that may best fit the user's risk profile, regulatory environment, capacity, and existing operations.

The electronic trading application may assist the user in developing an optimal carbon management strategy by providing a variety of information. The user may view information on developing an optimal strategy. The user may view information related to internal emissions management, including analysis of marginal abatement costs and examples of initiatives undertaken by other corporations. The user may also obtain strategic consideration information on purchasing credits and allowance. The user may also view information on carbon risk management that may assist in enhancing the flexibility of an adopted strategy.

Develop a reductions project step 38 may be the next stage in trade cycle 30. Projects that may be developed under Joint Implementation (JI) and Clean Development Mechanism (CDM) flexibility mechanisms may represent opportunities for users to secure low cost emissions reductions. The user may view eligibility criteria to obtain more information on earning emission reductions. The user may also view information related to developing project baselines, sequestration quantification, technical engineering, and project documentation through the electronic trading application.

The electronic trading application may offer a choice of specialist services to assist in developing the user's emission reduction project. A range of individual or packaged engineering solutions may be available for every stage of the user's project from concept development to the start-up of operations. Technical assistance may also be available for determining the eligibility of the user's project to earn emissions reductions, determining baselines and emission reductions and developing monitoring and reporting systems.

Develop a reductions project step 38 may focus on issues associated with the development of external reduction projects. From an operational perspective, internal and external emission reduction or sequestration projects may be similar. External emissions reduction projects may be outside existing business operations. Emissions reduction or sequestration projects may first meet a series of eligibility criteria under the Kyoto protocol or under other suitable protocols. It may be necessary to be able to satisfy data requirements and methodologies for developing project baselines and sequestration quantification. The requirements may be reflected in the technical engineering of the project. Before ensuring eligibility and proceeding with financing, it may be necessary for the user to compile appropriate project documentation.

Verify and monitor emissions reductions step 40 may be the next step of trade cycle 30, and may focus on the verification of historic and future streams of emission reductions. CO2e Associates may assist the user by providing independent greenhouse gas emissions verification services involving analytical review of data acquisition process, assessment and testing of internal controls, and the validation of data.

Register emission reductions step 42 may be the next step in trade cycle 30. Before the establishment of regulatory accreditation procedures, independent emission reduction registries may assume many of their roles. Each registry may apply its own criteria to determine what emissions may merit registration. Depending upon the registry used, registering the user's emission reductions may create a reliable record of the user's accomplishments, provide a statement of quality and enhance the marketability of the user's emission reductions.

The user may be provided with the ability to register emission reductions with a reputable registry to enhance marketability through the registrar's attestation that criteria have been satisfied, or, in the case of forward-looking registration, may expected to be satisfied. Registrars provide guidelines for the determination and verification of emission reductions, and establishment of a contractual title to, and transfer of, the emission reductions.

The user may view information on the types of emissions registered, current and future roles of registries, and the benefits of registration on the electronic trading application.

Register emission reductions step 42 may not address registration or reporting to regulatory bodies that are, or may be, required for the purpose of protecting a user's emissions baseline, or making claims of additionality, early action or compliance.

Obtain financial advice step 44 may be a necessary step whether the user is a buyer or a seller. The user may request expert advice on financial and climate change advice from the electronic trading application hosts, from CO₂e Associates, or from a link on the electronic trading application to a third-party vendor of information.

Specialized financial advice may become very important during trade cycle 30. The electronic trading application may provide information on several key areas. The electronic trading application may provide information on the financial impact of climate change, which may provide details on how financial advice and analysis may be a component to any corporate or project strategy overview. The electronic trading application may also allow the user to select project financial solution information, which may provide guidance on how a financial adviser may add value to emissions reduction projects and what services to expect. The electronic trading application may also allow the user to select structured financial solutions information which may discuss what value may be extracted from a stream of emissions reductions, including securitization and funds management.

Obtain insurance advice step 46 may be a step in trade cycle 30 for the user who is either a buyer or a seller. The user may seek insurance services to provide enhanced security to the user's climate change investments and marketability to the user's reductions. The user may select to view information on risk optimization of carbon offset projects and trading to help avoid setbacks, reduce unnecessary exposures, provide access to alternative sources of project finance and enhance the competitiveness of the user's offers to sell emission reductions. The user may select an option from the electronic trading application to view a selection of insurance providers. The user may also select an option to request insurance advice.

Obtain legal advice step 48 may be another stage in trading cycle 30 for users who are either buyers or sellers. There may be legal issues associated with aspects of every stage of the trade cycle. The user's strategic analysis may require a review of contractual exposure to cost transfer. Sellers may need to view available information on integrated project advice, and buyers may need to understand the legal validity of project based emission reductions which they may be buying.

Using the electronic trading application, the user may obtain information on suitable legal counsel. A wide range of legal expertise may be sought for climate change related transactions, developing a legal framework for climate change, project development advice, issues of legal title and validity of purchases of emissions reductions, what may occur in the event of errors in verification and accreditation, public liability issues, regulatory issues, and any other suitable legal topics.

The electronic trading application may provide information on a variety of legal issues which may arise at different stages of the trade cycle. Information may be available on contractual exposure to cost transfer. This information may discuss the ways in which proper legal due diligence and planning in contracting for services may help manage the pass-through of climate change related costs in contractual relationships. The electronic trading application may also provide integrated project advice information. The user may be able to select information on the aspects of a typical project where the need for legal advice may be more than typical project development issues. The electronic trading application may also provide information on the legal validity of project based emissions reductions. The user may view information on issues surrounding traded emission reductions which may need to be considered by both buyers and sellers of project based credits.

Enter the market step 50 may be the final step in trade cycle 30. The electronic trading application may provide a series of briefing information to the user on trading. The briefing information may include emissions trading concepts which may describe technical aspects of emissions trading principles. The briefing information may discuss the types of instruments that may be traded. The briefing information may also include information on trading under the Kyoto protocol or other related treaties on environmental regulation. Briefing information on current market practices how trading may be applied under the guidelines of climate change legislation to date. Market sizing and pricing forecasts may be available from the electronic trading application.

Using the electronic trading application, the user may select to view information on internal trading, which may provide information related to advantages and practicalities of market development. The user may also select to view information on current market practices may provide discussion on users who are already trading in the external market and are starting to standardize the way transactions occur. The user may also select to view information on project indexation that may provide details on emission reductions streams on the forward market.

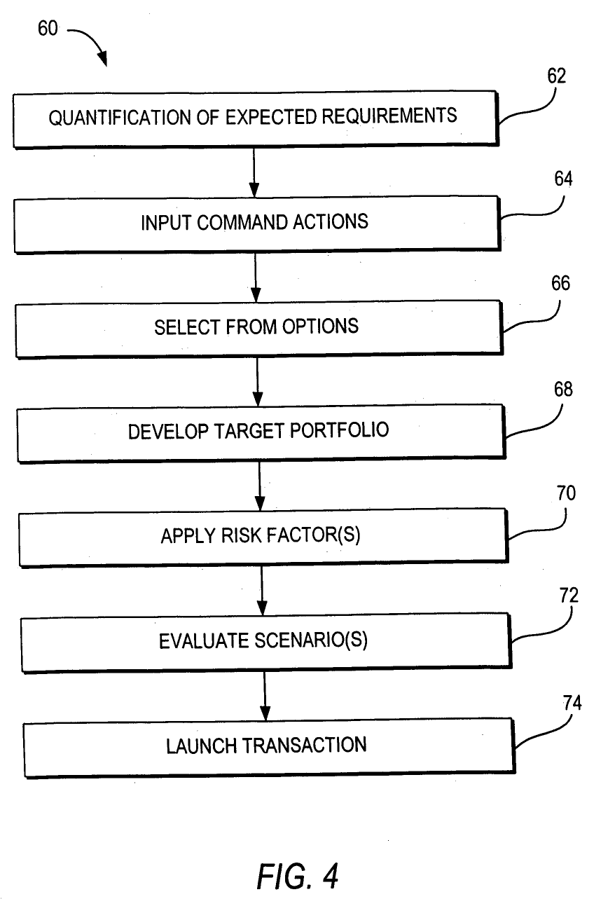

FIG. 4 shows a flow diagram for portfolio building method 60 that may be provided by the electronic trading application in accordance with some embodiments of the present invention. As shown, portfolio building method 60 may include quantification of expected requirements step 62, input committed actions step 64, select from options step 66, develop target portfolio step 68, apply risk factors step 70, evaluate scenarios step 72, launch transaction step 74, or any other suitable steps for portfolio building.

A portfolio builder method aspect of the electronic trading application may facilitate the acquisition of the tonnes required to meet expected future obligations. The portfolio builder may be used as both a planning tool and an execution tool. It may allow an analyst to develop and test multiple strategies for review by management or committee. The portfolio builder may allow a compliance trader or individual user to initiate purchases and sales directly after determining how a particular element fits into an existing mix of elements in a portfolio. The portfolio builder may also assist a trader in procuring a portfolio of reductions with high expected value and low cost.

The portfolio builder may facilitate exploration of uncertainty by allowing the user to create, analyze, and save multiple portfolio scenarios. Through continued evaluation, modification, and refinement of a plurality of portfolios, the user or CO₂e Assistants may identify a company's most significant emissions exposures and develop a plan that may provide a protection strategy.

The portfolio builder may assist the user in designing a reduction portfolio in a series of focused tasks. The portfolio builder may guide the user through the process of forecasting requirements, designing a balanced portfolio which may include reductions and offsets from internal projects and market purchases. Each task may be repeatedly revisited and refined as required. Using the portfolio builder, the user may focus efforts on the elements that are most critical at any time, and may progress with their evaluation in light of incomplete and changing information.

The first step in portfolio building method 60 may be quantification of expected requirements step 62. Expected requirements may be the difference in tonnes between a company's forecast greenhouse gas emissions under a “business as usual” scenario and the anticipated target emissions under a future regulatory or self-imposed emissions constraint. The portfolio builder may have the flexibility to allow the user to either calculate the user's forecast emissions and target by using an emissions gap calculator, or input a target number of tonnes.

The next step in portfolio building process 60 may be input committed actions step 64. With a future requirements forecast, the user may begin to define their strategy by populating a portfolio with previously committed activities, both internal and external. Such activities may belong in the portfolio rather than the baseline projections so they may be readily adjusted if the expected results change. This representation may facilitate the examination, selling off or swapping out of a portion of an already acquired portfolio in order to potential achieve greater diversity, or for potentially greater financial gain.

Next, in select from options step 66, the portfolio builder may facilitate the comparison of the range of compliance options across a common metric. Options may include clean development mechanisms (CDM), joint implementations (JI), early action reductions, Annex B reductions, internal reduction projects or any other suitable options. Reduction options may be differentiated by the probability of their recognition under future compliance regimes. The portfolio builder may allow for a direct comparison of the risk-adjusted investment of internal and external options by seeking to promote a balanced and rational investment.

The design of a target portfolio may be determined by the user's weighing of the different risk factors involved with each reduction opportunity in develop target portfolios step 68. The portfolio builder may allow the user to select a balanced portfolio containing items that are spread across a range of project types, geographical locations, or other risk factors for emission reduction projects. The top-down selection approach of the portfolio builder may allow the user to allocate the portfolio target by category. The user may first have an opportunity to “get it right” at a high level. Next, the top-down approach may allow the user to resolve the details of constructing a specifically tailored portfolio.

The ability of the user to observe how the portfolio may be spread across a range of possible options in an easy-to-understand tabular format may ease portfolio construction. The format of the portfolio builder may facilitate this goal.

Risk factors may be applied to the number of tonnes purchased and used to determine the probable or expected number of tonnes realized in apply risk factors step 70. This may allow the user to make direct comparisons between seemingly different options. The combination of price and quality may determine value. Adding higher risk tonnes to a portfolio may require purchasing more tonnes than required but may yield a less costly portfolio than a strategy of buying only the “highest quality” reductions.

Every element of the portfolio may have a user-defined risk factor. The portfolio builder may give the user flexibility to define the risk level associated with each particular project. Risk factors may include political, categorical, quantitative, and project based risks, or any other suitable risk factors. Risk factors may be applicable to entire categories of reductions or may be option specific. Risk factors may vary considerably across national programs.

Scenario evaluation step 72 may involve the ability to generate a plurality of portfolios with different risk elements and risk factors that may allow the user to test a variety of potential portfolios. Different structures may be analyzed in light of evolving policy. Structures may be prepared to support specific actions, or to facilitate discussion on compliance strategies.

The portfolio builder may permit the user to track the value of the user's actual or hypothetical portfolios over time. The portfolio builder may allow the user to “mark-to-market” elements of their portfolios against actual bids and offers in the marketplace.

Transactions in the form of either purchases or sales may be launched directly from the portfolio builder in launch transactions step 74. Once the user is satisfied that either a generic type of reduction or a specific purchase opportunity may fit the portfolio, a bid may be generated against that type of reduction. Similarly, if the user determines a need to move out of a previously acquired portion of their portfolio, a sales offer may be generated. A direct link to the trading board may allow for synergies between the portfolio builder and the trading market.

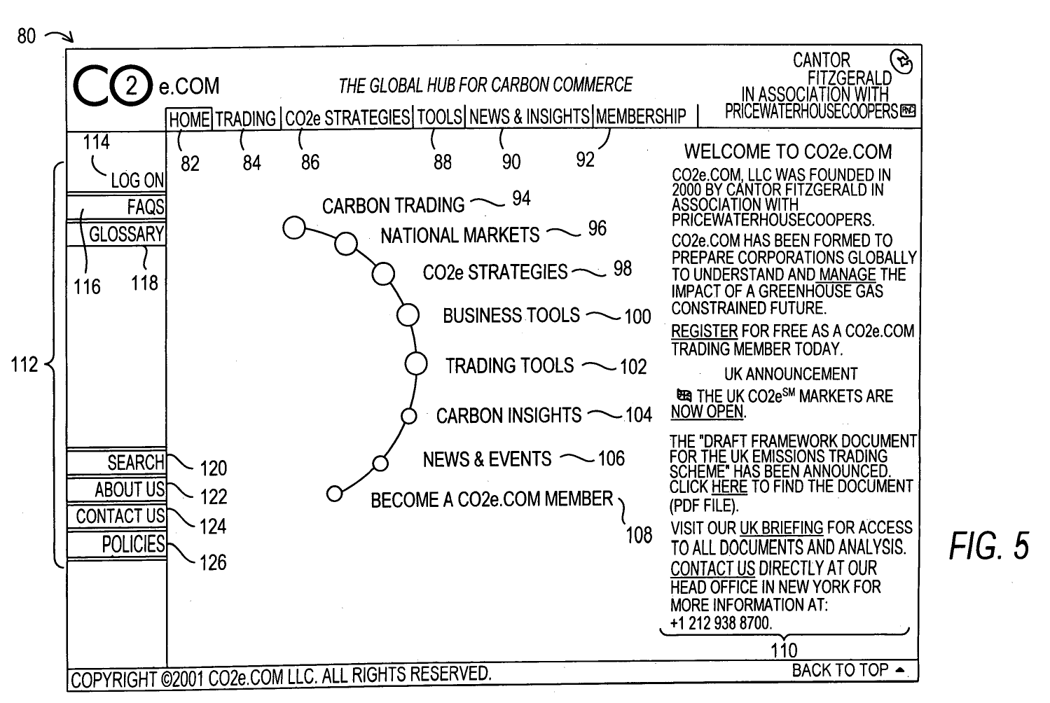

Referring now to FIGS. 5-16, illustrative screens that may be provided by an electronic trading application are provided. The format and contents of such screens may be modified to accommodate displays of different sizes and shapes, such as computer monitors and laptop computer displays (as shown), handheld computer displays, personal digital assistant displays, or any other suitable displays.

FIG. 5 shows an illustrative main menu screen 80 that may be provided to the user by the electronic trading application in accordance with some embodiments of the present invention. Main menu screen 80 may be provided when the user initially accesses the electronic trading application. Main menu screen 80 may provide the user with options in connection with carbon trading and carbon management. As shown, main menu screen 80 may include tabs such as a home tab 82, a trading tab 84, a CO2e strategies tab 86, a tools tab 88, a news and insights tab 90, a membership tab 92, or any other suitable tab. These tabs may allow the user to access menu screens associated with the tabs by, for example, navigating a pointer arrow over the tabs and pressing an appropriate key on a mouse or a keyboard. The user may use such an approach or any other suitable approach in this screen and the screens that follow to select any on-screen selectable options.

Main menu screen 80 may include options such as a carbon trading option 94, a national markets option 96, a CO2e strategies option 98, a business tools option 100, a trading tools option 102, a carbon insights option 104, a news and events option 106, a become a CO2e.com member option 108, or any other suitable option. When the user selects an option, the electronic trading application may display a menu screen associated with the option. The menu screen displayed when the user selects an option may correspond to a menu screen provided when the user selects a corresponding tab. For example, the electronic trading application may provide the user with the same menu screen when the user selects membership tab 92 and when the user selects become a CO2e.com member option 108.

Main menu screen 80 may include an announcements area 110. Announcements area 110 may include greetings, information about the trading web site, contact information, current news items that are related to the web site or to CO₂e emission reductions, or any other suitable announcements.

Main menu screen 80 may include a side menu area 112 that provides the user with selectable options. Side menu area 112 may be accessible from various screens of the electronic trading application. Side menu area 112 may include a log on option 114, a frequently asked questions (FAQs) option 116, a glossary option 118, a search option 120, an about us option 122, a contact us option 124, a policies option 126, or any other suitable option.

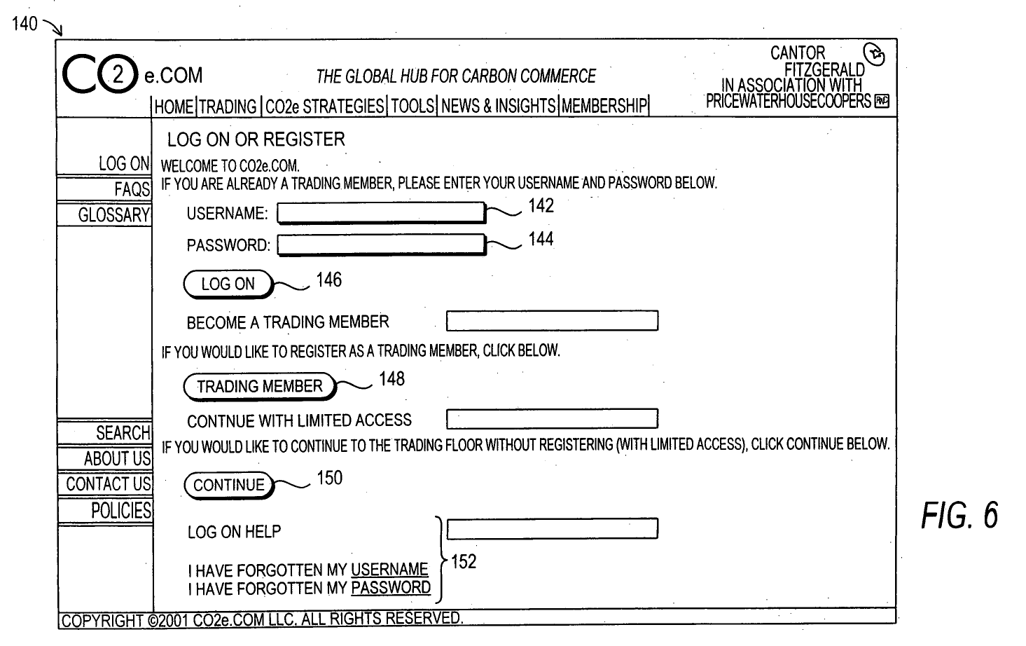

Various screens of the electronic trading application, such as information screens that contain general information about the trading application, may be available to any user of the electronic trading application. However, to access screens provided by the electronic trading application that are reserved for registered users only, the user may log onto the electronic trading system or register to become a member. The user may select log on option 114 from side menu area 112 to access a log on screen such as that displayed in FIG. 6.

FIG. 6 shows an illustrative log on screen 140 that may be provided to the user by the electronic trading application in accordance with some embodiments of the present invention. As shown, log on screen 140 may include a username text box 142, a password text box 144, a log on button 146, a trading member registration button 148, a continue with limited access button 150, a log on help area 152, or any other suitable items related to logging onto the electronic trading application.

Username text box 142 may be any suitable area where a trading member or user of the electronic trading application may enter a username. Password text box 144 may be any suitable area where the user may enter a password corresponding to the username entered in username text box 142. The user may enter the username and password by, for example, navigating a pointer arrow over text boxes 142 and 144, pressing an appropriate key on a mouse or a keyboard such that a cursor appears, and inputting text using a keyboard or other suitable device. The user may use such an approach in this screen and the screens that follow to enter text in a text box.

The user may select log on button 146 after entering the username and password in boxes 302 and 304, respectively. When the user selects log on button 306, the electronic trading application may, for example, log the user onto the web site provided by the electronic trading application.

Trading member registration button 148 may provide a user who is not already a trading member with a registration screen (not shown) that may allow the user to register as a trading member.

Continue with limited access button 150 may be selected by a user if the user would like to access limited trading functions without registering to become a trading member.

Log on help area 152 may provide the user with assistance in logging onto the web site. For example, log on help area 310 may help the user recover a forgotten username or password.

When the user selects log on button 146 of FIG. 6, the electronic trading application may provide the user with main menu screen 80 of FIG. 5. The electronic trading application may, however, provide a log out option in the place of a log on option 114. Because the user is logged on, the electronic trading application may provide the user with access to a trading menu screen. The user may access a trading menu screen by selecting trading tab 84 or carbon trading option 94 of FIG. 5.

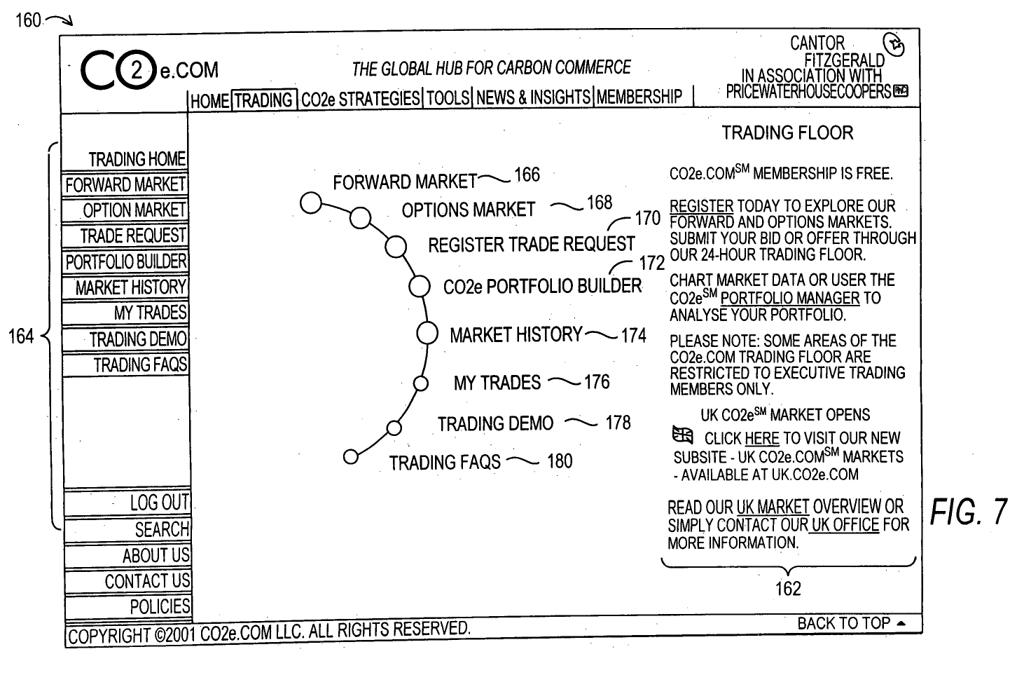

FIG. 7 shows an illustrative trading menu screen 160 that may be provided to the user by the electronic trading application in accordance with some embodiments of the present invention. From this menu, the user may access trading tools related to CO₂e emission reductions. As shown, trading menu screen 160 may include an announcements area 162 and a side menu area 164. Trading menu screen 160 may include trading options such as a forward market option 166, an options market option 168, a register trade request option 170, a CO2e profile builder option 172, a market history option 174, a my trades option 176, a trading demo 178, a trading FAQs 180, or any other suitable options related to trading.

Announcements area 162 may include greetings, information about the electronic trading application, contact information, membership information, market information, current news items related to electronic trading application, or any other relevant information.

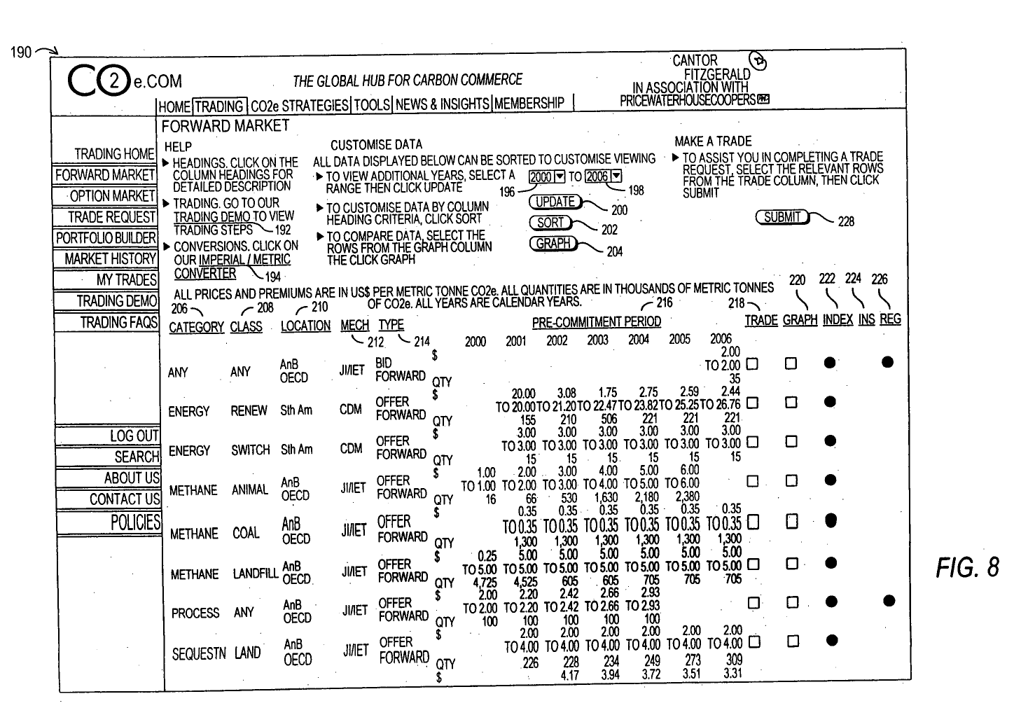

Side menu area 164 may include options that provide the user with the ability to access screens that are related to trading. Side menu area 164 may be included in any of FIGS. 8-15 (e.g., the trading screens that are provided to the user). For example, side menu area 164 may include a trading home option, a forward market option, a option market option, a trade request option, a portfolio builder option, a market history option, a my trades option, a trading demo option, a trading FAQs, or any other suitable options related to trading. Side menu area 164 may include general options such as a log out option, a search option, an about us option, a contact us option, a policies option, or any other suitable general options.

FIG. 8 shows an illustrative forward market screen 190 that may be provided to the user by the electronic trading application in accordance with some embodiments of the present invention. The electronic trading application may display forward market screen 190 when the user selects forward market option 166 or the forward market option in side menu area 164 of FIG. 7. As shown, forward market screen 190 may include a trading demo function 192, an imperial/metric converter function 194, a first drop-down box 196, a second drop-down box 198, an update button 200, a sort button 202, a graph button 204, a category column 206, a class column 208, a location column 210, a mechanism column 212, a type column 214, a pre-commitment period columns 216, a trade column 218, a graph column 220, an index column 222, an insurance column 224, a registration column 226, a submit trade button 228, or any other suitable forward market items.

Trading demo function 192 may allow the user to understand the operation and use of the electronic trading application. When the user selects function 192, the electronic trading application may provide examples and illustrations to guide the user through the various steps of the trade cycle.

Another tool available from forward market screen 190 to help the user is imperial/metric converter function 194. When the user selects converter function 194, the electronic trading application may display an imperial/metric converter screen that may allow the user to convert between imperial units and metric units for quantities of weight, area, or any other suitable quantities.

FIG. 8 shows an illustrative imperial/metric converter screen that may be provided to the user by the electronic trading application in accordance with some embodiments of the present invention. Imperial/metric converter screen 240 may include a weight quantity converter function 242, a weight conversion item text box 244, a first weight unit drop-down box 246, a second weight unit drop-down box 248, a calculate button 250, an area quantity converter function 252, an area conversion item text box 254, a first area unit drop-down box 256, a second area unit drop-down box 258, a calculate button 260, or any other suitable converter functions.

The user may enter a weight quantity to be converted in weight conversion item text box 244. The user may select the unit of weight for the entered item from first weight unit drop-down box 246. The user may then select the conversion unit for the entered item from second weight unit drop-down box 248. Available weight units in drop-down boxes 246 and 248 may include pounds, short tons, metric tonnes, kilograms, or any other suitable weight unit. The user may convert from one selected weight unit to another selected weight unit by selecting calculate button 250.

The user may enter an area quantity to be converted in area conversion item text box 254. The user may select the area conversion unit for the item from first area unit drop-down box 256. The user may then select the conversion unit for the item from second area unit drop-down box 258. Available area units in drop-down boxes 256 and 258 may include square feet, square yards, acres, hectares, square miles, square metres, square kilometres, or any other suitable area unit. The user may convert from one selected area unit to another selected area unit by selecting calculate button 260.

Referring back to FIG. 8, forward market screen 190 may provide the user with several means for customising the display of the forward market data. In one suitable approach, the user may select a range of years for which data may appear by using first drop-down box 196 and second drop-down box 198. When the start year has been selected in drop-down box 196 and the end year selected in drop-down box 198, the user may select update button 200 to apply the selected year range to the data displayed in the pre-commitment period columns 216. In another suitable approach, the user may customise the forward market data by column heading criteria by selecting sort button 202 as described in more detail below. In another suitable approach, the user may customise the forward market data in a graphical form by using graph button 204 as described in more detail below.

Category column 206 may include project categories such as carbon sequestration (Sequestn), energy use (Energy), methane recovery (Methane), process change (Non-energy or any), or any other suitable project categories. Carbon sequestration may be a category which may refer to projects that capture and store carbon in a manner that prevents it from being released into the atmosphere for a specified period of time. The storage area is commonly known as a carbon sink. Energy use is a category that may refer to energy improved utilization of energy sources that reduce the emissions intensity of energy-based systems. Methane recovery is a category which may relate to the capture and re-use of methane emissions either through cost-effective management methods or through power generations. Process change may be a category which may relate to an improvement of the emissions associated directly with a manufacturing process. For example, a process change may be improving the recycled content in an aluminum smelting process.

Class column 208 may display the class of the category listed in category column 206. The classes carbon sequestration category may include forest sequestration, land conservation, soil conservation and land use, waste CO2 recovery/deep injection, or any other suitable carbon sequestration category class. Forest sequestration may include afforestation and reforestation. Afforestation may refer to the process of establishing a forest on land not previously forested. Reforestation may refer to increasing the capacity of the land to sequester carbon by replanting forest biomass in areas where forests were recently harvested. Land conservation may prevent the release of carbon into the atmosphere, which occurs when lands come into production (i.e., agriculture), by preventing lands from coming into production. Soil conservation and land use may relate to land management programs to result in a net sequestration of soil carbon. Waste CO₂ recovery may relate to projects that capture vented CO₂ from an industrial source.

The classes of the energy use category may include building efficiency, commercial/industrial efficiency, fuel switching, renewable energy, transportation, or any other suitable class. Building efficiency may relate to energy efficiency for heating, cooling, and lighting and the use of energy-saving appliances. Commercial/industrial efficiency projects may reduce fuel consumption and emissions by applying technologies in intensive industries. For example, practices may include manufacturing and refining processes, cogeneration,, and efficient energy usage, especially with electric motors and drives. Fuel switching may refer to the substitution of conventional and existing technologies for more efficient and less carbon-intensive fueling technologies including repowering, upgrading instrumentation, controls, and/or equipment, more efficient utilization of fuel and fuel switching. Renewable energy may be electricity that is generated using renewable energy sources (solar, photovoltaic, wind, geothermal, hydroelectric technologies) and which may adhere to sustainable development practices. Transportation may include private and public passenger and freight transports.

The methane recovery category may include classes such as animal waste methane recovery, coal bed methane, landfill/biomass capture, or any other suitable methane recovery class. Animal waste recovery may relate to installation of animal waste decomposition methane recovery technologies to capture methane to produce energy. Coal bed methane recovery may relate to projects that capture methane released from coal bed seams during the mining process for energy use. Landfill/biomass capture may relate to capturing methane produce from landfill decomposition which may normally migrate into the atmosphere.

The process change recovery category may include the class of process change or any other suitable process change class. Process change may relate to the improvement of the emissions associated directly with a manufacturing process.

Location column 210 may display the trading board definitions for locations of emission reduction projects. Location headings may include South America (Sth Am), Africa, Middle East (Mid East), Central Asia (Cen Asia), East Asia and Pacific (E AsPac), Annex B OECD (AnB OCED), Annex B Other (AnB Othr), Central America (Cen Am), or any other suitable location.

Mechanism column 212 may include joint implementation and international emission trading (JI/IET), clean development mechanism (CDM), or any other suitable mechanism. Joint implementation may refer to emission reduction projects jointly implemented by entities within different industrial nations. International emissions trading (IET) may relate to a flexibility mechanism in the Kyoto Protocol or other similar agreements which may allow the trade of Assigned Amount Units (AAUs) among Annex B countries. Clean development mechanism (CDM) may be a mechanism established, such as by Article 12 of the Kyoto Protocol, for project-based emission reduction activities in developing countries. CDM may be designed to address the sustainable development needs of the host country and to increase the opportunities available to parties to meet their reduction commitments.

Type column 214 may refer to the type of trade. This may include bid/buy and offer/sell. The types of instruments may include forward or any other suitable instrument.

Pre-commitment period columns 216 may contain data from the year range as selected by the user with drop-down boxes 196 and 198. The pre-commitment period may refer to the period prior to the first Kyoto Commitment Period or any other suitable treaty precommitment period.

Trade column 218 may contain selectable boxes which may allow the user to indicate that the user would like to engage in a transaction where the buyer and seller exchange a recognized commodity. The user may complete the trade request after selection of items by selecting submit button 228.

Graph column 220 may have a series of user-selectable boxes which may allow a user to select information to be represented in graphical form. The user may initially select the information to be graphed, and then select graph button 204 in order to display a graph of the selected information as described below.

Index column 222 may provide a rating of the listing of items.

Insurance column 224 may be used to identify those emission reduction offers whose underlying emission reduction projects may have obtained at least one type of insurance coverage. Types of insurance coverage may include political, business interruption, constructors all risks, operators all risks, advance loss of revenue or profits, emission reduction generator performance guarantee, or any other suitable type of insurance coverage. The insurance indicator may be most useful when interpreted in conjunction with the CO₂e Project Index which may indicate the stage of development of the emission reduction project. However, not all offerors may elect to have their underlying project assessed or insured.

Registration column 226 may relate to the process of registering emission reduction data with a third party registry. Column 226 may denote which items have been registered with a third party registry.

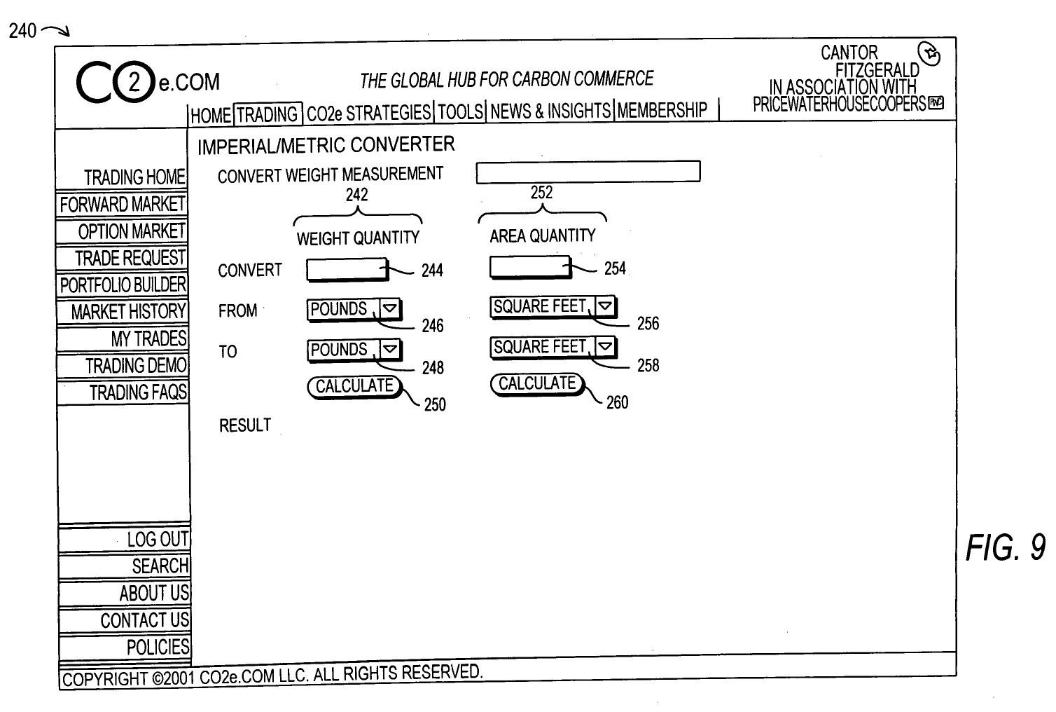

As described above, the user may customise the forward market data by selecting sort button 202. FIG. 9 shows an illustrative customisation screen 270 that may be provided to the user by the electronic trading application when the user selects sort button 202. As shown, customisation screen 270 may include a category customisation scroll listing 272, a class customisation scroll listing 274, a location customisation scroll listing 276, a mechanism customisation window 278, a type customisation drop-down boxes 280, an insurance filter drop-down box 282, a registered filter drop-down box 284, an update button 286, a clear all button 288, or any other suitable customisation option.

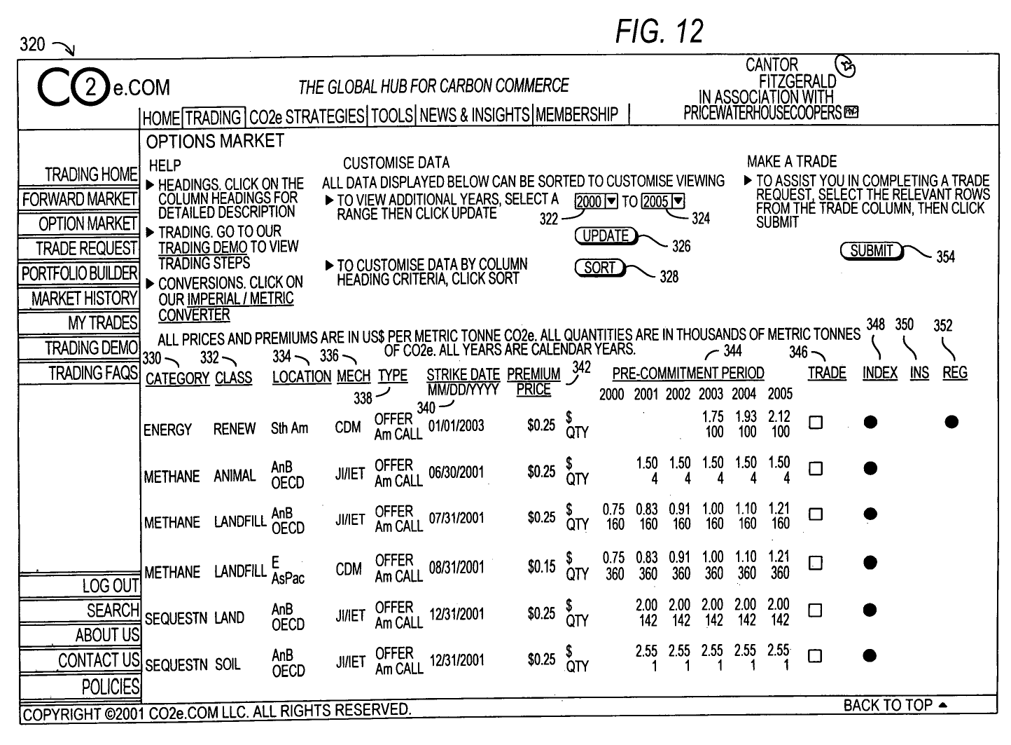

Category customisation scroll listing 272 may be used to tailor the information displayed in forward market screen 190 of FIG. 8, option market screen 320 of FIG. 12, or other screens of the electronic trading application. Multiple selections of categories may be made. Available categories may include carbon sequestration, energy use, methane recovery, process change, combinations of categories or other suitable categories.

Class customisation scroll listing 274 may be used to tailor the information displayed in forward market screen 190 of FIG. 8, option market screen 320 of FIG. 12, or other screens of the electronic trading application. The class customization options for the carbon sequestration category may include forest sequestration, land conservation, soil conservation and land use, waste CO₂ recovery/deep injection, or any other suitable carbon sequestration options. The class customisation options for the energy use category may include building efficiency, commercial/industrial efficiency, fuel switching, renewable energy, transportation, or any other suitable options. The class customisation options for the methane recovery category may include animal waste methane recovery, coal bed methane, landfill/biomass capture, or any other suitable methane recovery options. The class customisation options for the process change category may be process change or any other suitable process change options.

Location customisation scroll menu 276 may include options for South America, Africa, Middle East, Central Asia, East Asia and Pacific, Annex B OECD, Annex B Other, Central America, or any other suitable options.

Mechanism customisation window 278 may include options for CDM, JI/IET, UKET, UKPBR, or any other suitable option.

Type customisation drop-down boxes 280 may include one drop-down box that may allow a user to select offer, bid, or any other suitable option. A second drop-down box may allow a user to select all, forward, or any other suitable option.

User customisation of the information presented may include filtering of information. Users may filter insurance information with insurance filter 282, and registration information with registration filter 284.

Upon completion of customisation, a user may select update button 286. If the user would like to reset the selections, the user may select clear all button 288.

When the user selects update button 286, the electronic trading application may provide the user with forward market screen 190 as shown in FIG. 8 with the forward market data customised according to the user's customisation selections.

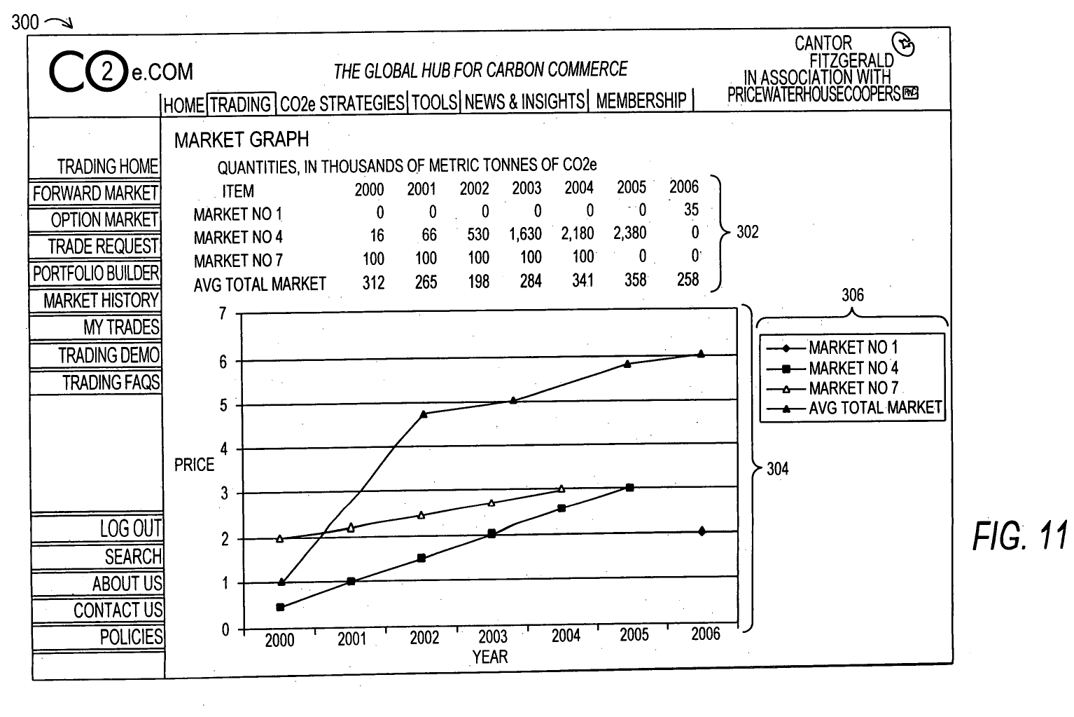

As described above, the user may customise the forward market data in a graphical form by selecting graph button 204. FIG. 11 shows an illustrative market graph 300 that may be provided to the user by the electronic trading application when the user selects graph button 204. As shown, market graph 300 may include market data table 302, graph 304, and legend 306.

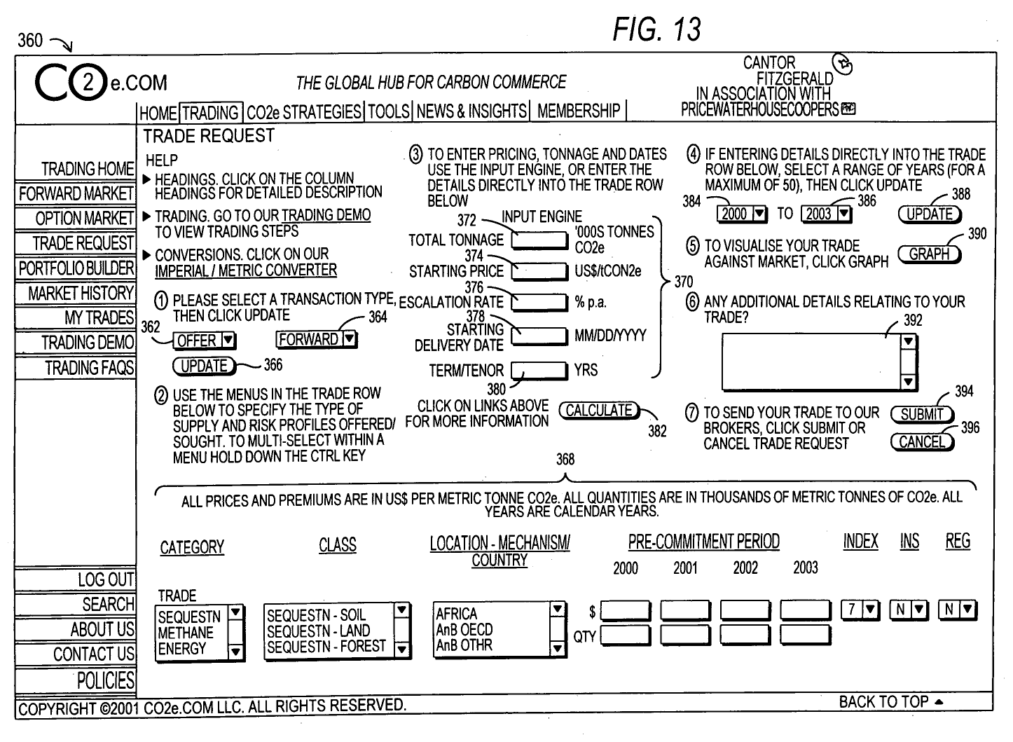

Market data table 302 may include the data for the items selected by the user in forward market screen 190 of FIG. 8 or trade request screen 360 of FIG. 13 that is placed in graphical form.

Graph 304 may be the graphical representation of the data items selected by the user in forward market screen 190 of FIG. 8 or trade request screen 360 of FIG. 13. Legend 306 may provide the user with information regarding which lines of the graph represent which sets of selected data.

FIG. 12 shows an illustrative options market screen 320 that may be provided to the user by the electronic trading application in accordance with some embodiments of the present invention. Options market screen 320 may be provided when the user selects-options market option 168 of FIG. 7 or the options market option from side menu area 164 from any screen which includes side menu area 164. As shown, options market screen 320 may include a first drop-down box 322, a second-drop-down box 324, an update button 326, a sort button 328, a category column 330, a class column 332, a location column 334, a mechanism column 336, a type column 338, a strike date column 340, a premium price column 342, a pre-commitment period columns 344, a trade column 346, an index column 348, an insurance column 350, a registration column 352, a submit trade button 354, or any other suitable options market items.

Options market screen 320 may provide the user with several means for customising the display of the options market data. In one suitable approach, the user may select a range of years for which data may appear by using first drop-down box 322 and second drop-down box 324. When the start year has been selected in drop-down box 322 and the end year selected in drop-down box 324, the user may select update button 326 to apply the selected year range to the data displayed in pre-commitment period columns 344. In another suitable approach, the user may customise the options market data by column heading criteria by selecting sort button 328. Sort button 328 may allow the user to customise the options market data in a substantially similar way as sort button 202 of FIG. 8 allows the user to customise the forward market data.

Category column 330 of FIG. 11 may include project categories such as carbon sequestration (Sequestn), energy use (Energy), methane recovery (Methane), process change (Non-energy or any), or any other suitable project categories.

Class column 332 may display the class of the category listed in category column 330. The classes for the carbon sequestration category may include forest sequestration, land conservation, soil conservation and land use, waste CO2 recovery/deep injection, or any other suitable carbon sequestration category class.

Location column 334 may display the trading board definitions for locations of emission reduction projects. Location headings may include South America (Sth Am), Africa, Middle East (Mid East), Central Asia (Cen Asia), East Asia and Pacific (E AsPac), Annex B OECD (AnB OCED), Annex B Other (AnB Othr), Central America (Cen Am), or any other suitable location.

Mechanism column 336 may include joint implementation and international emission trading (JI/IET), clean development mechanism (CDM), or any other suitable mechanism.

Type column 338 may refer to the type of trade. This may include bid/buy and offer/sell. The types of instruments may include American call option, American put option, European call option, European put option, or any other suitable options instrument.

Strike date column 340 may provide the expiration date of an option. Options are contracts that give the option buyer the right but not the obligation to enter into a specific transaction purchase (a Call) or sale (Put) up to a certain date. The price (Strike Price), quantity and terms of delivery are locked in at the trade date. The expiration or exercise date (Strike Dates) may also be locked in at that time, which is the date after which the option buyer's rights to enter into the transaction terminate. The option seller must live by the decision of the buyer, and may be paid a premium for selling the optionality or flexibility to the buyer.

Premium price column 342 may relate to a premium price that a put or call seller must pay to a put or call for an option contract. The premium may be determined by the market forces of supply and demand.

Pre-commitment period columns 344 may contain data from the year range as selected by the user with drop-down boxes 322 and 324. The pre-commitment period may refer to the period prior to the first Kyoto Commitment Period or a pre-commitment period of any other relevant treaty or protocol.

Trade column 346 may contain selectable boxes which may allow the user to indicate that the user would like to engage in a transaction where the buyer and seller exchange a recognized commodity. The user may complete a trade request for the selected items by selecting submit button 354.

Index column 348 may provide a rating of the listing of items.

Insurance column 350 may be used to identify emission reduction offers whose underlying emission reduction projects may have obtained at least one type of insurance coverage. Types of insurance coverage may include political, business interruption, constructors all risks, operators all risks, advance loss of revenue or profits, emission reduction generator performance guarantee, or any other suitable type of insurance coverage. The insurance indicator may be most useful when interpreted in conjunction with the CO2e Project Index which may indicate the stage of development of the emission reduction project. However, not all offerors may elect to have their underlying project assessed or insured.

Registration column 352 may relate to the process of registering emission reduction data with a third party registry. Column 352 may denote which items have been registered with a third party registry.

FIG. 13 shows an illustrative trade request screen 360 that may be provided to the user by the electronic trading application in accordance with some embodiments of the present invention. Trade request screen 360 may be provided when the user selects register trade request option 170 of FIG. 7 or the trade request option from side menu area 164 from any screen which includes side menu area 164. As shown, trade request screen 360 may include a first transaction type drop-down box 362, a second transaction type drop down box 364, an update button 366, a trade information area 368, an input engine 370, a total tonnage text box 372, a starting price text box 374, an escalation rate text box 376, a starting delivery date text box 378, a term/tenor text box 380, a calculate button 382, a first drop-down box 384, a second drop-down box 386, an update button 388, a graph button 390, a trade details text box 392, a submit button 394, and a cancel button 396.

First transaction type drop-down box 362 may allow the user to select whether the trade request involves a bid or an offer. The second transaction type drop-down box 364 may allow the user to select whether the trade request is a forward, EU call, EU put, Am call, Am put, or any other suitable trade type. Once a user has selected the trade type, the user may select update button 366 in order to update the trade information displayed on the screen.

Trade information area 368 may include information regarding the characteristics of the trade. Area 368 may be organized into columns of information. The columns of information may include category, class, location/mechanism/country, pre-commitment period, index, insurance, registration, or any other suitable column of information. The user may use the text boxes, scroll boxes, and drop-down boxes in area 368 to specify the type of supply and risk profiles offered/sought. Multiple selections may be made.

Input engine 370 may allow the user to enter information details related to a trade. Details may be entered by the user into total tonnage text box 372, starting price text box 374, escalation rate text box 376, starting delivery date text box 378, term/tenor text box 380, or into any other suitable details. The user may enter the total amount of tonnage of carbon emissions reductions that the user may wish to purchase into total tonnage text box 372. The user may enter the price of emission reductions (measured in US$/tCO2e) for the starting delivery date in a bid/offer for a forward contract in starting price text box 374. Input engine 370 may allow the user to use starting price text box 374 to enter the base price of the Escalation Rate that may be applied to the Tenor. Escalation rate text box 376 may contain the calculation factor that may determine cost increases to a bid or offer on a stream of reductions. Starting delivery date text box 378 may contain the first specified future date when the forward contract emission reductions may be delivered. Term/tenor text box 380 may be the period in time (measured in years) during which the conditions of a contract may be carried out. Once information has been entered into input engine 370, the user may select calculate button 382.

First drop-down box 384 may allow the user to set the first year in which information is displayed in trading information area 368. Second drop-down box 386 may allow the user to select the end year in which information is displayed in area 368. Upon selecting the range of years, the user may select update button 388 to update the information displayed in area 368 to reflect the selected year range.

Graph button 390 may provide the user with the ability to graph trading information selected by the user against the market.

Trade details text box 392 may be a text box where a user may enter additional details, comments or other suitable information related to the trade.

Submit button 394 may provide the user with the ability to send the trade to a broker. Cancel button 396 may be selected by a user to cancel a trade request.

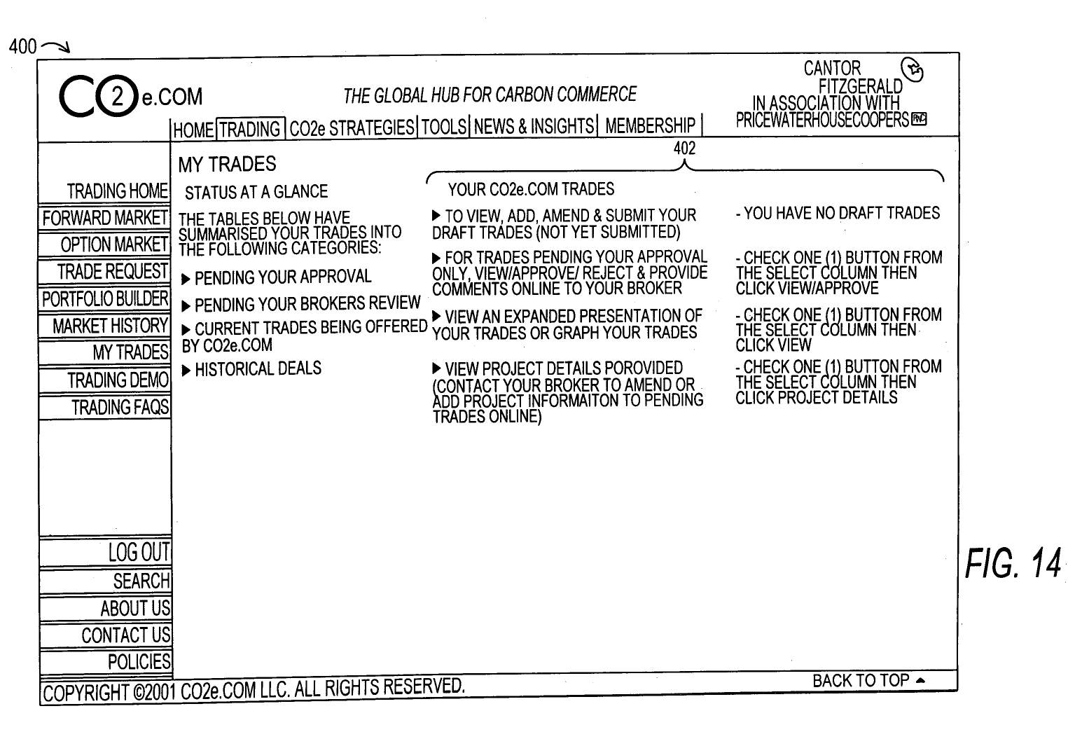

FIG. 14 shows an illustrative my trades screen 400 that may be provide to the user by the electronic trading application in accordance with some embodiments of the present invention. My trades screen 400 may be provided when the user selects my trades option 176 of FIG. 7 or the my trades option from side menu area 164 from any screen which includes side menu area 164. Trade screen 400 may include trade listing 402.

Trade listing 402 may indicate a user's draft. trades. The user may view, add, amend, or submit draft trades. If a trade is merely pending the user's approval, the user may view, approve, reject or provide comments to a broker for the trade. The user may view an expanded presentation of the user's trades or graph the trades. The user may also view project details.

My trades screen 400 may also provide the user with the ability to view trades pending a brokers review, current trades being offered, and historical deals.

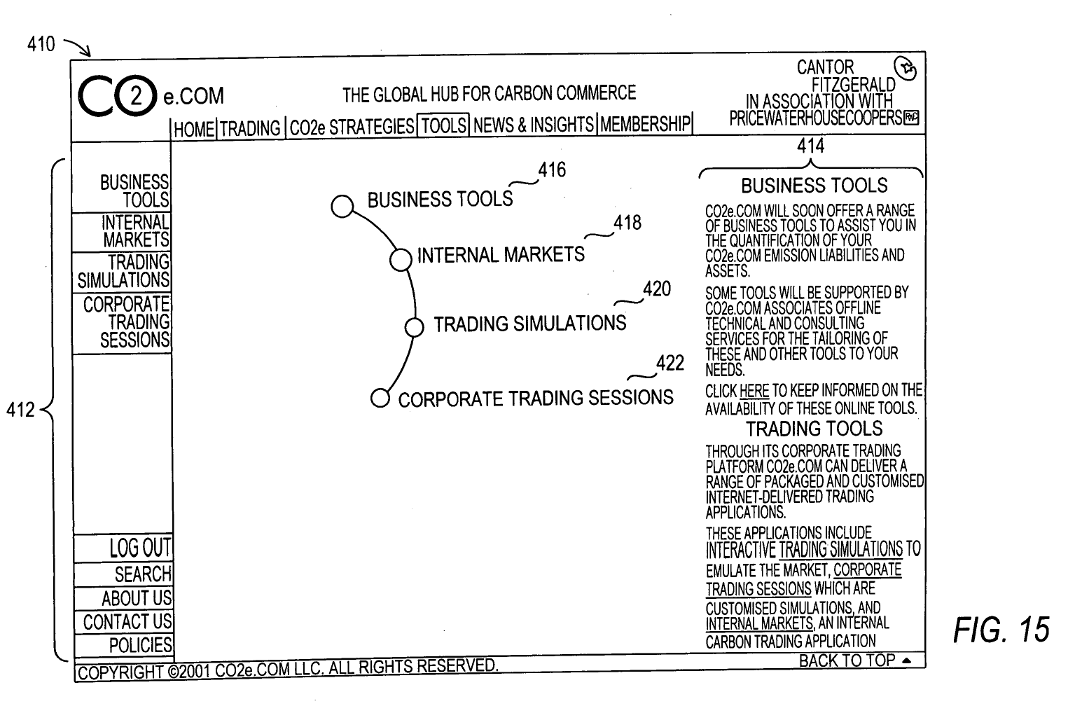

FIG. 15 shows an illustrative tools menu screen 410 that may be provided to the user by the electronic trading application in accordance with some embodiments of the present invention. Main menu screen 410 may be provided when the user selects tools tab 88 from any suitable screen or trading tools option 102 of FIG. 5. Main menu screen 410 may provide the user with options in connection with electronic trading. As shown, tools menu screen 410 may include a side menu area 412, an announcements area 414, a business tools-option 416, an internal markets option 418, a trading simulations option 420, and a corporate trading sessions option 422.

Side menu area 412 may include options for allowing the user to access tools-related screens. For example, side menu area 412 may include a business tools option, an internal markets trading simulations option, a corporate trading sessions option, or any other suitable options related to tools. Side menu area 412 may include general options such as a log out option, a search option, an about us option, a contact us option, a policies option, or any other suitable general options.

Announcements area 414 may include information related to business tools, trading tools, internal markets, trading simulations, corporate trading sessions, or any other suitable information.

When the user selects business tools option 416, the electronic trading application may provide the user with access to various business tools to assist the user in the quantification of the user's emission liabilities and assets. When the user selects internal markets option 418, the electronic trading application may provide the user with access to an internal carbon trading application. When the user selects trading simulations option 420, the electronic trading application may provide the user with access to an electronic trading simulation that may emulate market behavior. When the user selects corporate trading sessions option 422, the electronic trading application may provide the user with access to engage in customised trading simulations.

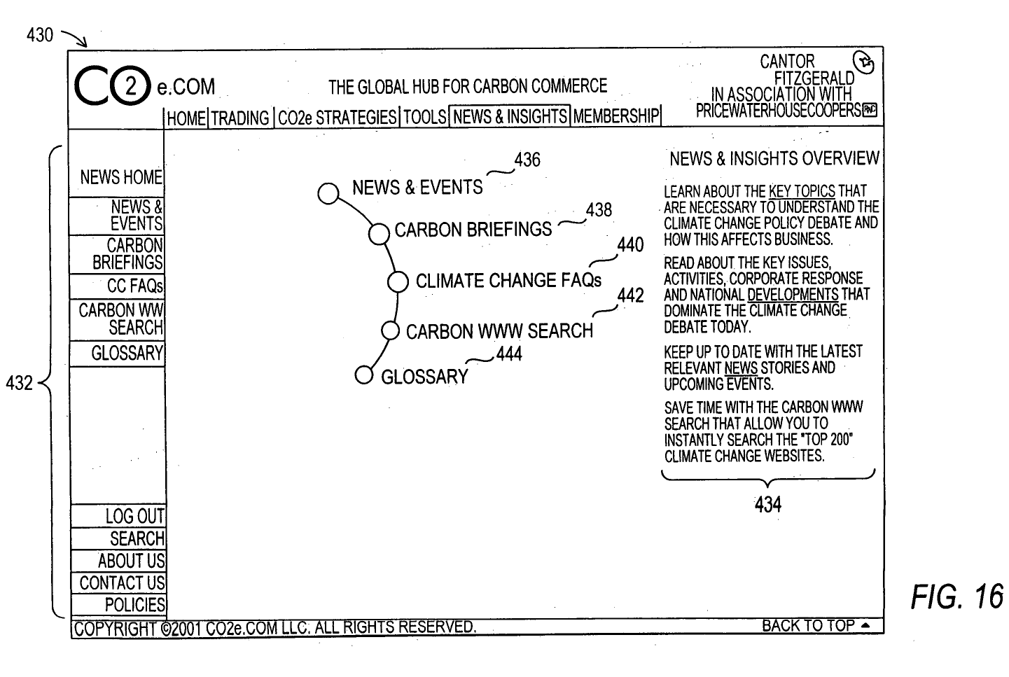

FIG. 16 shows an illustrative news and insights menu screen 430 that may be provided to the user by the electronic trading application in accordance with some embodiments of the present invention. News and insights menu screen 430 may be provided when the user selects news and insights tab 90 or news and events option 106 of FIG. 5. As shown, news and insights menu screen 430 may include side menu area 432, announcements area 434, news and events option 436, carbon briefing option 438, climate change FAQs option 440, carbon WWW search option 442, and glossary option 444.

Side menu area 432 may contain options for allowing the user to access news and insights screens. For example, side menu area 432 may include a news home option, a news and events option, a carbon briefings option, a CC FAQs option, a Carbon WW search option, a glossary option, or any other suitable options related to news and insights. Side menu area 432 may include general options such as a log out option, a search option, an about us option, a contact us option, a policies option, or any other suitable general options.

Announcements area 434 may display recent or important news items related to carbon commerce.

When the user selects news and events option 436, the electronic trading application may provide the user with access to a listing of recent news items related to carbon commerce. When the user selects carbon briefings option 438, the electronic trading application may provide the user with access to a separate screen that may provide summaries of climate change issues that may impact a user's business. When the user selects climate change FAQs option 440, the electronic trading application may provide the user with access to a listing of frequently asked questions by users. The user may select a frequently asked question from the listing to view a discussion related to the selected question.

When the user selects carbon WWW search option 442, the electronic trading application may provide the user with the ability to search for key words in the electronic trading application or other selected climate change web sites. The user may also be provided with the ability to perform a more complex search.

When the user selects glossary option 444, the electronic trading application may provide the user with a compilation of terms and definitions that may be employed throughout the electronic trading application.

Accordingly, systems and methods for electronic trading of carbon dioxide equivalent emission reductions are provided. It will be understood that the foregoing is merely illustrative of the principles of the invention and the various modifications can be made by those skilled in the art without departing from the scope and spirit of the invention, which is limited only by the claims that follow.

1-14. (canceled)

15. A method for electronically building a portfolio of carbon dioxide equivalent emission reductions using an electronic trading application, comprising:
quantifying expected requirements, wherein the quantification comprises determining the difference in tonnes of carbon dioxide equivalent emissions under a company's current practices and under a regulatory or self-imposed emissions restraint;
allowing a user at a user computer to input committed actions using the electronic trading application, wherein the inputting comprises populating an electronic portfolio with carbon dioxide equivalent emission reduction activities;
allowing the user at the user computer to select from a plurality of compliance options using the electronic trading application;
comparing the selected compliance options across a common metric with the electronic trading application;
allowing the user at the user computer to develop a balanced portfolio using the electronic trading application, wherein the development of the balanced portfolio is based at least in part on risk factors associated with each carbon dioxide equivalent emission reduction activity;
applying at least one risk factor to the number of carbon dioxide equivalent emission reduction tonnes purchased to determine the expected number of carbon dioxide equivalent emission reduction tonnes realized;
evaluating a scenario using the electronic trading application, wherein the evaluation is based at least in part on tests of a plurality of portfolios with different risk factors; and
allowing the user at the user computer to enter into a transaction using the electronic trading application, wherein the transaction is a purchase or a sale of the carbon dioxide equivalent emission reductions.

16. A method for electronically building a portfolio of carbon dioxide equivalent emission reductions using an electronic trading application, comprising:
quantifying expected requirements, wherein the quantification comprises determining the difference in tonnes of carbon dioxide equivalent emissions under a company's current practices and under a regulatory or self-imposed emissions restraint;
allowing a user at a user computer to input committed actions using the electronic trading application, wherein the inputting comprises populating an electronic portfolio with carbon dioxide equivalent emission reduction activities;
allowing the user at the user computer to select from a plurality of compliance options using the electronic trading application;
comparing the selected compliance options across a common metric with the electronic trading application;
allowing the user at the user computer to develop a balanced portfolio using the electronic trading application, wherein the development of the balanced portfolio is based at least in part on risk factors associated with each carbon dioxide equivalent emission reduction activity;
applying at least one risk factor to the number of carbon dioxide equivalent emission reduction tonnes purchased to determine the expected number of carbon dioxide equivalent emission reduction tonnes realized;
evaluating a scenario using the electronic trading application, wherein the evaluation is based at least in part on tests of a plurality of portfolios with different risk factors; and
allowing the user at the user computer to enter into a transaction using the electronic trading application, wherein the transaction relates to a derivative product based on the carbon dioxide equivalent emission reductions.

17. The method of claim 16, wherein the derivative product is at least one of a forward trade, a call option and a put option.

18. The method of claim 16, further comprising:
displaying at least one of forward market data and options market data relating to at least one derivative product; and
allowing the user at the user computer to customize the display of the at least one of the forward market data and the options market data.

19. The method of claim 18, wherein allowing the user at the user computer to customize the display, further comprises:
allowing the user at the user computer to select a year range for the data to be displayed in the pre-commitment period.

20. The method of claim 18, wherein allowing the user to customize the display, further comprises:
allowing the user at the user computer to customize the at least one of the forward market data and the options market data in a graphical form.

21. The method of claim 18, wherein allowing the user to customize the display, further comprises:
allowing the user at the user computer to sort the at least one of the forward market data and the options market data according to the user's customization selections.

22. The method of claim 21, wherein the user's customization selections are at least one of project categories, class categories, location of emission reduction projects, mechanism categories, type of trade, strike date and premium price.

23. Apparatus for electronically building a portfolio of carbon dioxide equivalent emission reductions using an electronic trading application, comprising:
means for quantifying expected requirements, wherein the means for quantification comprises means for determining the difference in tonnes of carbon dioxide equivalent emissions under a company's current practices and under a regulatory or self-imposed emissions restraint;
means for allowing a user at a user computer to input committed actions using the electronic trading application, wherein the inputting comprises populating an electronic portfolio with carbon dioxide equivalent emission reduction activities;
means for allowing the user at the user computer to select from a plurality of compliance options using the electronic trading application;
means for comparing the selected compliance options across a common metric with the electronic trading application;
means for allowing the user at the user computer to develop a balanced portfolio using the electronic trading application, wherein the development of the balanced portfolio is based at least in part on risk factors associated with each carbon dioxide equivalent emission reduction activity;
means for applying at least one risk factor to the number of carbon dioxide equivalent emission reduction tonnes purchased to determine the expected number of carbon dioxide equivalent emission reduction tonnes realized;
means for evaluating a scenario using the electronic trading application, wherein the evaluation is based at least in part on tests of a plurality of portfolios with different risk factors; and
means for allowing the user at the user computer to enter into a transaction using the electronic trading application, wherein the transaction is a purchase or a sale of the carbon dioxide equivalent emission reductions.

24. Apparatus for electronically building a portfolio of carbon dioxide equivalent emission reductions using an electronic trading application, comprising:
means for quantifying expected requirements, wherein the means for quantification comprises means for determining the difference in tonnes of carbon dioxide equivalent emissions under a company's current practices and under a regulatory or self-imposed emissions restraint;
means for allowing a user at a user computer to input committed actions using the electronic trading application, wherein the inputting comprises populating an electronic portfolio with carbon dioxide equivalent emission reduction activities;
means for allowing the user at the user computer to select from a plurality of compliance options using the electronic trading application;
means for comparing the selected compliance options across a common metric with the electronic trading application;
means for allowing the user at the user computer to develop a balanced portfolio using the electronic trading application, wherein the development of the balanced portfolio is based at least in part on risk factors associated with each carbon dioxide equivalent emission reduction activity;
means for applying at least one risk factor to the number of carbon dioxide equivalent emission reduction tonnes purchased to determine the expected number of carbon dioxide equivalent emission reduction tonnes realized;
means for evaluating a scenario using the electronic trading application, wherein the evaluation is based at least in part on tests of a plurality of portfolios with different risk factors; and
means for allowing the user at the user computer to enter into a transaction using the electronic trading application, wherein the transaction relates to a derivative product based on the carbon dioxide equivalent emission reductions.

25. The apparatus of claim 24, wherein the derivative product is at least one of a forward trade, a call option and a put option.

26. The apparatus of claim 24, further comprising:
means for displaying at least one of forward market data or options market data relating to at least one derivative product; and
means for allowing the user at the user computer to customize the display of the at least one of the forward market data or the options market data.

27. The apparatus of claim 26, wherein the means for allowing the user at the user computer to customize the display, further comprises:
means for allowing the user at the user computer to select a year range for the data to be displayed in the pre-commitment period.

28. The apparatus of claim 26, wherein the means for allowing the user to customize the display, further comprises:
means for allowing the user at the user computer to customize the at least one of the forward market data or the options market data in a graphical form.

29. The apparatus of claim 26, wherein the means for allowing the user to customize the display, further comprises:
means for allowing the user at the user computer to sort the at least one of the forward market data or the options market data according to the user's customization selections.

30. The apparatus of claim 29, wherein the user's customization selections are at least one of project categories, class categories, location of emission reduction projects, mechanism categories, type of trade, strike date and premium price.
